(19) United States
(12) Patent Application Publication
(10) Pub. No.: US 2017/0336931 A1
(43) Pub. Date: Nov. 23, 2017

(54) INFORMATION-ENTERTAINMENT SYSTEM FOR A MOTOR VEHICLE AND METHOD FOR OPERATION THEREOF

(71) Applicant: DAIMLER AG, Stuttgart (DE)

(72) Inventors: Christian KLAUCKE, Stuttgart (DE); Ulf KÜHNAPFEL, Stuttgart (DE)

(21) Appl. No.: 15/534,065

(22) PCT Filed: Jul. 10, 2015
(86) PCT No.: PCT/EP2015/001417

§ 371 Date: Jun. 8, 2017

(30) Foreign Application Priority Data
Dec. 9, 2014 (DE) 10 2014 018 116.2

(51) Int. Cl. G06F 3/0482; B60K 35/00; G06F 3/14

(52) U.S. Cl. CPC G06F 3/0482; G06F 3/14; B60K 35/00; B60K 2350/352; B60K 2350/355

(57) ABSTRACT

An information entertainment system for a motor vehicle, includes a display unit for displaying at least one function, which can be activated or is activated by a user, and/or a piece of content of the information entertainment system to an occupant of the motor vehicle. The system also includes a control unit, for controlling the display unit and the function, having an interface for the information technological coupling a portable additional device to the control unit. The control unit supplements the function displayed on the display unit with a switching function after the coupling of the additional device and, upon activation of the switching function, to display a function of the additional device using the display unit. At least the switching function can be represented as a superordinate function covering other pieces of content displayed on the display unit to simplify integration of a third-party information entertainment system into a motor vehicle.

### BACKGROUND AND SUMMARY OF THE INVENTION

Exemplary embodiments of the invention relate to an information entertainment system for a motor vehicle and a method for operating such an information entertainment system.

When integrating information entertainment systems or infotainment systems of third-party manufacturers, so-called third-party infotainment systems, there are two infotainment systems or two infotainment software systems in the motor vehicle alongside each other. Such systems are, for example, CarPlay by Apple, Google's Android Auto and the independent MirrorLink. Each of these provide a so-called Remote User Interface, or Remote UI, which provides pieces of content and functions for a head unit or control unit of an information entertainment system as a telematics software system from an external device such as a smartphone. These systems provide, among other things, similar functions or functionalities, such as the telematics software systems which are usually already installed in motor vehicles, for example media playback, navigation, telephone services, access to the World Wide Web and the like.

German patent document DE 10 2014 100 183 A1 discloses a method for controlling a transfer of a piece of media content between a portable device and a main control unit in a motor vehicle. A first coupling is established to transfer control signals between a control client and a control server and a second coupling is established to transfer the piece of media content between a data server and a data client. The piece of media content is issued to a user via a media output device in the motor vehicle.

Exemplary embodiments of the present invention are directed to simplifying the integration of an information entertainment system of a third-party manufacturer into a motor vehicle.

An information entertainment system or infotainment system for a motor vehicle according to the invention comprises a display unit for displaying at least one function and/or piece of content, for example a piece of media content, which can be activated or is activated by a user, of the information entertainment system to an occupant of the motor vehicle. It also comprises a control unit for controlling the display unit and the functions, which can be activated or are activated by the user, as well as an interface for information technological coupling of a portable additional device to the control unit. Here, information technological coupling is to be understood, in particular, as a wired or wireless electrical or electronic coupling for transferring information in the form of data signals. Coupling can, in particular, take place using a wireless local area network connection (WLAN), a Bluetooth connection or a Universal Serial Bus connection. In order to simplify the integration of an information entertainment system of a third-party manufacturer, the control unit is designed, after coupling of the additional device, to supplement the functions displayed on the display unit with a switching function and, upon activation of the switching function, to display at least one function, which can be activated or is activated by the user, of the additional device by means of the display unit. Here, at least the switching function can be represented as a superordinate function that covers other pieces of content displayed on the display unit regardless of their nature.

The switching function for the external additional device can thus appear in a menu accessible from all areas of the telematics software of the information entertainment system via a predetermined number of operating actions of the user, in particular one operating action. The operating action can be an actuation of a predetermined operating element, for example a so-called “home button”. The menu can be designed as a so-called overlay menu, which can be placed over all content displayed on the display unit. The user can activate the telematics software from the overlay menu and thus the Remote User Interface of the external additional device by actuating or activating the switching function in the corresponding menu option. In particular, the Remote User Interface is only initialized by activating the switching function and not by merely coupling the additional device to the information entertainment system. Thus, for example, the additional device can be electrically charged after being electrically coupled to the information entertainment system, even without its Remote User Interface being activated. There is thus a separation between a charging function and an initialization or starting of the telematics software of the information entertainment system of the third-party manufacturer. The control unit can be designed to deactivate the Remote User Interface after its activation upon deactivation of the switching function.

This has the advantage that two infotainment systems can thus be used in the vehicle at the same time. By means of the switching function and its representation as a superordinate function, for example in an overlay menu, a function of the additional device can be activated quickly and simply, i.e., according to the Remote User Interface. Even if the switching function is not activated, an automatic charging function can be activated for the portable additional device. Furthermore, it is possible to switch back and forth between the information entertainment system of the third-party manufacturer and the vehicle's own information entertainment system in a simple and intuitive manner from all areas of the information entertainment system or its representation on the display unit. The Remote User Interface of the third-party manufacturer can be quickly terminated from all areas of the menu. The user can thus quickly and easily switch on and off a Remote User Interface provided by an additional device or a second infotainment system in the motor vehicle.

In an advantageous embodiment, the at least one function of the information entertainment system and the switching function can be represented as superordinate functions, i.e., for example, as the abovementioned overlay menu covering other pieces of content and/or functions displayed on the display unit regardless of their nature. This has the advantage that the user always has, from any area of the menu, an overview of the functions that can be activated in the information entertainment system, regardless of the information entertainment system being used at that time or regardless of the configuration of the Remote User Interface set by the specific third-party manufacturer.

In a further embodiment, the control unit is designed, when the switching function is activated, to no longer display a function of the information entertainment system corresponding to the displayed function of the additional device by means of the display unit and, in particular, to deactivate the function, if it is activated before the activation of the switching function. This is advantageous because the functions displayed on the display unit are clearer and, in particular, several different instances of a similar or functionally identical functionality or function cannot be active at the same time. This can otherwise lead to conflicts in the information entertainment system and to confusion for a user and to a possible road hazard.

In one preferred embodiment, the control unit is designed, upon deactivation of the activated switching function, to no longer display the function of the additional device and, in particular, to deactivate the function if it is activated. This also advantageously increases the clarity and a user is not confused by a display of a function of the additional device that is no longer available. Moreover, it can thus be prevented that a function of the additional device unintentionally continues to run and, for example, as described in the previous paragraph, unintentionally blocks a function of the information entertainment system which corresponds to a function of the additional device, or leads to confusion of the user.

In a particularly preferred embodiment, the control unit is designed to reactivate, upon deactivation of the switching function, a function of the information entertainment system that was deactivated by or during the activation of the switching function. This has the advantage that the information entertainment system is at least partially reset to a state corresponding to the state before the activation of the switching function. This is particularly intuitive and convenient for the user.

In a further embodiment, the control unit is designed to replace, upon activation of the switching function, a piece of display content provided by the information entertainment system itself and displayed by means of the display unit with a piece if display content provided by the additional device. This has the advantage that a piece of display content can be adapted to features or capabilities of the additional device.

In particular, the entire display content provided by the information entertainment system, in particular a user interface as a whole, can be replaced by the display content provided by the additional device, in particular the Remote User Interface. This may be the case, in particular, at times. In particular, the display content provided by the additional device comprises a display of a back-replacement function that can be activated by the user, the triggering or activation of which replaces the display content on the display unit provided by the additional device with the display content provided by the information entertainment system. This has the advantage that both the information entertainment system of the motor vehicle and the functionality or the user interface of the additional device can be used at the same time and it is possible to switch back and forth quickly and easily between the two infotainment systems in the motor vehicle. By complete replacement of the display content, the user always knows in which area or which telematics software they are navigating at that time, i.e., whether functions of the information entertainment system or of the additional device are controlled by the user at that moment.

The invention also comprises a communication system for a motor vehicle having an information entertainment system according to the invention and a portable additional device which is formed as a smartphone.

Furthermore, the invention comprises a method for operating an information entertainment system of a motor vehicle. A step of the method according to the invention is to display at least one function, which can be activated or is activated by a user, and/or one piece of content of the information entertainment system to an occupant of the motor vehicle by a display unit of the information entertainment system. A further step is to control the display unit and the function that can be activated or is activated by the user by means of a control unit of the information entertainment system. A further step is an information technological coupling of a portable additional device to the control unit via an interface of the information entertainment system. Essential for the invention here is supplementing the function displayed on the display unit with a switching function after the coupling of the additional device, as well as displaying a function of the additional device, which can be activated and/or is activated by the user, upon activation of the switching function. The switching function can be represented as a superordinate function which covers other pieces of content displayed on the display unit regardless of their nature.

Further advantages, features and details of the invention arise from the following description of a preferred exemplary embodiment and with the aid of the figures. The features and feature combinations cited in the description above and the features and feature combinations cited below in the description of the figures and/or shown in the figures alone can be used not only in each specified combination, but rather also in other combinations or individually, without exceeding the scope of the invention.

### BRIEF DESCRIPTION OF THE DRAWING FIGURES

Here are shown:

FIG. 1 an exemplary display unit of an exemplary embodiment of an information entertainment system at a first time point;

FIG. 2 the display unit from FIG. 1 at a second time point; and

FIG. 3 the display unit of FIG. 1 at a third time point.

The same or functionally identical elements are provided with the same reference numerals in the different figures.

### DETAILED DESCRIPTION

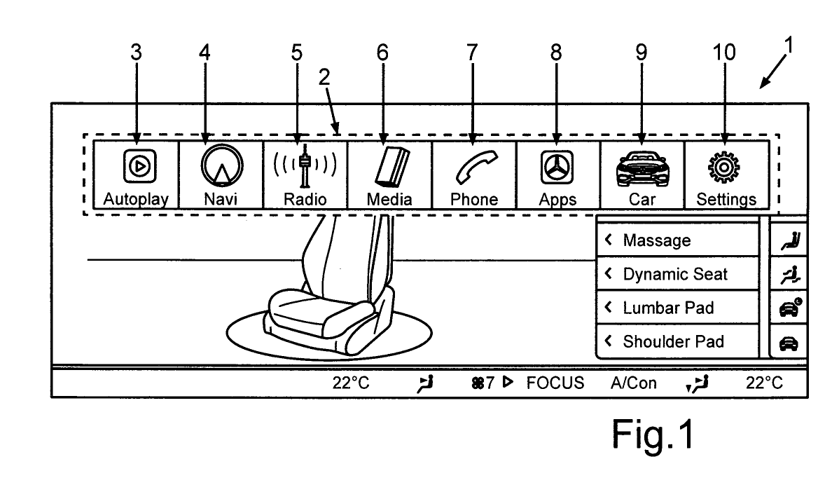

FIG. 1 shows an exemplary display unit of an exemplary embodiment of an information entertainment system at a first time point. In the present case, the display unit 1 is designed as a screen, for example as a touch screen. The pieces of content and functions are shown in FIG. 1 as they are shown to a user in a motor vehicle by the display unit 1. In the present case, a foreground is shown on the display unit 1 in a first partial region of the screen, and a background is shown in a second partial region of the screen. The foreground is formed here by a so-called overlay menu 2 that can be called-up in the depicted embodiment of the information entertainment system from all areas of the telematics software provided by the information entertainment system in this example by a single operating action, for example by one operating button, which is not shown here. In the example shown, the overlay menu 2 comprises a series of representations of functions 4, 5, 6, 7, 8, 9, 10 that can be activated or are activated by a user in the motor vehicle. In the present case, the representations are designed as operating tiles that can be selected, for example, by touching the touch screen. This allows the corresponding menu option or the corresponding function to be selected, i.e., activated or deactivated. The background is used to show other pieces of content, for example an illustration or a status of an activated function. In the present case, the background is used, for example, for visualizing a control of a massage function of the information entertainment system. The overlay menu 2 is fundamentally independent of the displayed pieces of content of the background in this example. It can be called up independently of the displayed pieces of content of the background and superimposes these.

In the present case, a user has coupled a portable or mobile additional device or terminal, for example a smartphone, via cable or a wireless connection to the information entertainment system shortly before the first time point. Correspondingly, the overlay menu 2 which, prior to the coupling, only represented the original functions 4, 5, 6, 7, 8, 9, 10 without a switching function 3, is supplemented with the switching function 3. The supplementing occurs here in the form of an additional menu option or an additional operating tile in the overlay menu 2. After the information-technological coupling of the additional device to the information entertainment system, there is initially full functionality of the information entertainment system with the original functions 4, 5, 6, 7, 8, 9, 10. However, from the overlay menu 2, the user can now activate the switching function 3, for example by tapping or selecting the corresponding operating tile or the corresponding menu option by means of a control unit.

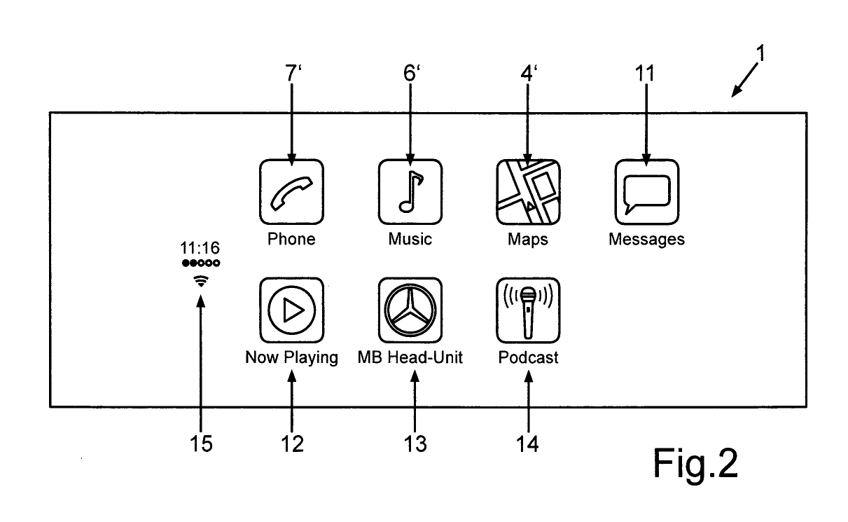

By activating the switching function 3, an initialization of the telematics software of a third-party manufacturer provided by the additional device takes place, for example a so-called Remote User Interface is provided. Upon activation of the switching function 3, the change to the Remote User Interface follows in the example shown. The display unit 1 is thus switched to a display of the user interface provided by the additional device, the Remote User Interface. The display unit 1 then shows functions or functionalities of the portable device, as shown in FIG. 2. In principle, functions of the information entertainment system of the motor vehicle that are active thus continue to run in the background. In the present case, however, functions that are also provided by the additional device are deactivated.

Provision may also be made for smooth switching, in which functions of the information entertainment system of the motor vehicle that are active initially continue to run, but are deactivated automatically at a later point in time. Thus, for example, a telephone function 7 can remain activated after coupling of an additional device designed as a smartphone when a telephone call is being carried out. The telephone call continues initially via the vehicle's own information entertainment system, even if a telephone function 7′ (FIG. 2) is also provided on the Remote User Interface. At the end of the telephone call, for example, the vehicle's own telephone function 7 is deactivated and telephone calls are only possible via the telephone function 7′ (FIG. 2) of the Remote User Interface.

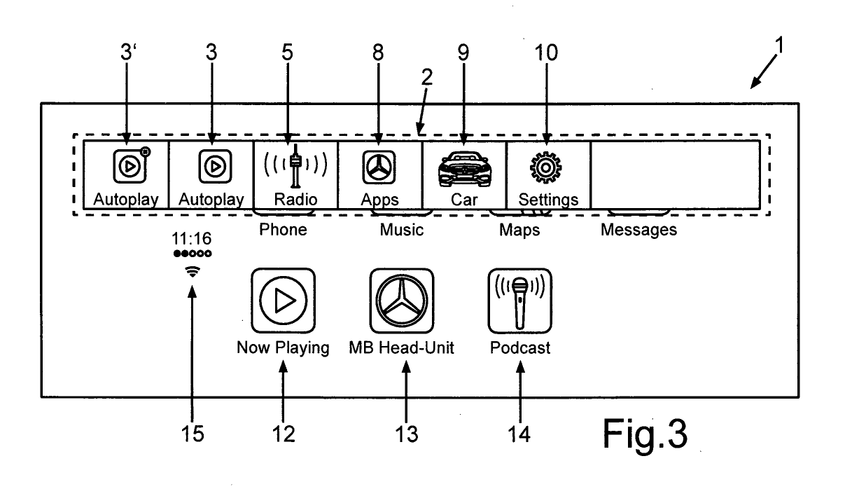

FIG. 2 shows the display unit 1 of FIG. 1 at a second time point in another display state. Shown here is a piece of content, the Remote User Interface provided by the additional device, without the overlay menu 2 shown in FIG. 1. The appearance differs here significantly from the background shown in FIG. 1. However, a series of functions 4′, 6′, 7′, 11, 12, 13, 14 and another piece of content 15 are also displayed. One of the functions 13 here is a back-replacement function, via which the vehicle's own telematics software can be switched back. Since, in the present case, a navigation function 4′, a playback function 6′ and a telephone function 7′ are provided by the Remote User Interface, the navigation function 4 (FIG. 1), the playback function 6 (FIG. 1) and the telephone function 7 (FIG. 1) of the vehicle's own information entertainment system are correspondingly deactivated in the example shown and no longer displayed when the overlay menu 2 is called up. This is also shown in FIG. 3.

FIG. 3 shows the display unit of FIG. 1 at a further time point at which a user has called up the overlay menu 2 that is known from FIG. 1 in the display state of the display unit 1 shown in FIG. 2, i.e., when the switching function is activated and the Remote User Interface provided by the additional device is displayed. This can be done, for example, as described above by using a hardware button. As is known from FIG. 1, the overlay menu 2 is placed over the content formed in this case by the Remote User Interface in the background. Since functions 4′, 6′, 7′ corresponding to the navigation function 4, the playback function 6 and the telephone function 7 are provided by the activated additional device, only the remaining functions 5, 8, 9, 10 of the information entertainment system of the motor vehicle are represented in the overlay menu 2. Since the additional device is coupled to the information entertainment system, the switching function 3 is also represented in the overlay menu 2 as before. Added to this is a function 3′ that deactivates this as part of the switching function 3.

The user can now access functions or applications, such as seat adjustments for example, directly in the information entertainment system of the motor vehicle via the overlay menu 2 via the additional functions 5, 8, 9. In addition, the functions offered and provided by the additional device continue to run in the background.

The user can also switch back to the Remote User Interface via the switching function 3, after which the display unit 1 offers the functions of the additional device, as shown, for example, in FIG. 2. In this case, the vehicle's own information entertainment system continues to run in the background.

The user can also quickly terminate the Remote User Interface via the additional function 3′. As a result, the full range of functions of the vehicle's own information entertainment system is available again, as is shown, for example, in FIG. 1. From this state, it is of course possible to reinitialize the functions provided by the additional device by activating the switching function 3 again, as shown in FIG. 1.

By means of the overlay menu 2, the user can thus switch back and forth between the telematics software of the motor vehicle and the telematics software of the additional device, the Remote User Interface. Actuating the deactivation function 3′ via the corresponding menu tile in the overlay menu 2 allows a quick deactivation of the Remote User Interface. As a result, the entire telematics software of the motor vehicle is available to the user once again without limitations to functionality. If the user wishes to use the Remote User Interface of the additional device, he/she can activate it via the switching function 3. The user can thus quickly and easily switch a Remote User Interface of an additional device on and off in the motor vehicle and use the corresponding functions in an intuitive manner.

Although the present invention has been described above by means of embodiments with reference to the enclosed drawings, it is understood that various changes and developments can be implemented without leaving the scope of the present invention, as it is defined in the enclosed claims.

1-9. (canceled)

10. An information entertainment system for a motor vehicle, the information entertainment system comprising:
a display unit configured to display at least one function, of the information entertainment system that is activatable by a user, or a piece of content of the information entertainment system to an occupant of the motor vehicle;
a control unit configured to control the display unit and the at least one function information entertainment system;
an interface configured for communicatively coupling a portable additional device to the control unit,
wherein the control unit is further configured to supplement the displayed at least one function of information entertainment system with a switching function after the coupling of the additional device and configured to display, upon activation of the switching function, a function of the additional device that is activatable by the user via the display unit,
wherein at least the switching function is displayed as a superordinate function covering other pieces of content displayed on the display unit regardless of their nature.

11. The information entertainment system of claim 10, wherein the at least one function of the information entertainment system and the switching function are represented as superordinate functions covering other pieces of content displayed on the display unit regardless of their nature.

12. The information entertainment system of claim 10, wherein the control unit is further configured, when the switching function is activated, to no longer display a function of the information entertainment system corresponding to a displayed function of the additional device via the display unit.

13. The information entertainment system of claim 12, wherein the control unit is further configured to deactivate the at least one function of the information entertainment system corresponding to a displayed function if the at least one function of the information entertainment system corresponding to the displayed function is activated before the activation of the switching function.

14. The information entertainment system of claim 10, wherein the control unit is further configured, upon deactivation of the activated switching function, to no longer display the function of the additional device, and to deactivate the function of the additional device if it is activated.

15. The information entertainment system of claim 13, wherein the control unit is further configured, upon deactivation of the switching function, to reactivate the at least one function of the information entertainment system that was deactivated by the activation of the switching function.

16. The information entertainment system of claim 10, wherein the control unit is further configured, upon activation of the switching function, to replace a piece of display content provided by the information entertainment system and displayed by the display unit with a piece of display content provided by the additional device.

17. The information entertainment system of claim 16, wherein
an entirety of the piece of display content provided by the information entertainment system is replaced by the display content provided by the additional device, and
the display content provided by the additional device comprises a display of a back-replacement function activatable by the user, the triggering of which replaces the display content provided by the additional device on the display unit with the display content provided by the information entertainment system.

18. The information entertainment system of claim 10, wherein the portable additional device is a smartphone.

19. A method for operating an information entertainment system of a motor vehicle, the method comprising:
displaying, to an occupant of the motor vehicle via a display, a function of the information entertainment system that is activatable by a user or a piece of content of the information entertainment system;
controlling, via a control unit, the display and the activateable function;
communicatively coupling a portable additional device to the control unit via an interface;
supplementing the activateable function displayed on the display with a switching function after the coupling of the additional device; and
displaying, upon activation of the switching function, a function of the additional device that is activatable by the user,
wherein the switching function is represented as a superordinate function covering other pieces of content displayed on the display regardless of their nature.

20. The method of claim 19, wherein when the switching function is activated, the method further comprises:
no longer displaying a function of the information entertainment system corresponding to a displayed function of the additional device via the display unit.

21. The method of claim 19, further comprising:
deactivating the at least one function of the information entertainment system corresponding to a displayed function if the at least one function of the information entertainment system corresponding to the displayed function is activated before the activation of the switching function.

22. The method of claim 19, wherein upon deactivation of the activated switching function the method further comprises:
no longer displaying the function of the additional device and deactivating the function of the additional device if it is activated; and
reactivating the at least one function of the information entertainment system that was deactivated by the activation of the switching function.

23. The method of claim 19, wherein upon activation of the switching function, the method further comprises:
replacing a piece of display content provided by the information entertainment system and displayed by the display unit with a piece of display content provided by the additional device.
